(19) United States
(12) Patent Application Publication
(10) Pub. No.: US 2009/0002318 A1
(43) Pub. Date: Jan. 1, 2009

(54) MOBILE COMMUNICATION DEVICE AND INPUT MODULE THEREOF

(75) Inventors: Sheng-yu YANG, Taipei (TW); Yen-chih Lin, Taipei (TW); Tzu Hsien Tung, Taipei (TW)

Correspondence Address: Muncy, Geissler, Olds & Lowe, PLLC, P.O. BOX 1364, FAIRFAX, VA, 22038-1364, US

(73) Assignee: ASUSTeK COMPUTER INC.

(21) Appl. No.: 12/136,441

(22) Filed: Jun. 10, 2008

(30) Foreign Application Priority Data
Jun. 27, 2007 (TW) 096123353

(51) Int. Cl. G06F 3/033

(52) U.S. Cl. 345/161

(57) ABSTRACT

An input module of a mobile communication device includes an interlinking unit, an input unit, and a pressing unit. The interlinking unit has a protrusion and a first sliding member. The input unit has a second sliding member opposite to the first sliding member. The pressing unit has a groove, a guiding member, and an elastic member. The groove and the interlinking unit move together. One end of the guiding member moves between a first position and a second position in the groove. The elastic member provides a resilience force for the groove. When an external force is applied to the protrusion of the interlinking unit, the interlinking unit drives the groove in a first direction to allow the guiding member to relatively move from the first position to the second position or from the second position to the first position. A mobile communication device is also provided.

### CROSS REFERENCE TO RELATED APPLICATIONS

This Non-provisional application claims priority under 35 U.S.C. §119(a) on Patent Application No(s). 096123353 filed in Taiwan, Republic of China on Jun. 27, 2007, the entire contents of which are hereby incorporated by reference.

### BACKGROUND OF THE INVENTION

1. Field of Invention

The invention relates to an input module and, more particularly, to an input module of a mobile communication device.

2. Related Art

As the mobile communication technology develops, mobile communication devices are closely related to people's life. As the mobile communication devices become important gradually, the facilitation demand of an input interface increases continuously. Therefore, various input interfaces are developed besides conventional keys. For example, a common joystick in cooperation with the conventional keys allows users to directly input instructions, such as moving up, down, left, or right of the cursor, by tilting it in the corresponding direction, or to confirm instructions by pressing it. Accordingly, the joystick is commonly called the five-direction button.

Please refer to FIG. 1. An input module 11 of a conventional mobile communication device 1 includes a joystick 111, a base 112, and a circuit substrate 113. The joystick 111 is disposed on the base 112 soldered on the circuit substrate 113. To facilitate the operation, the joystick 111 preferably protrudes from the surface of the mobile communication device 1. The joystick 111 is a slender rod. If the joystick 111 protrudes from the surface of the mobile communication device 1, the joystick 111 may be easily damaged because of sidelong external forces while operation. Therefore, in the prior art, the input module 11 is usually fixed in a cavity G at the surface of the mobile communication device 1 to prevent the joystick 111 from damage because of the excessive sidelong external forces.

However, although the joystick 111 can avoid being damaged by being fixed in the cavity G, it is difficult and unsmooth to tilt the joystick 111 up, down, left, or right. Thus more forces have to be applied to the joystick 111 for operating the joystick 111 well, thereby resulting in users' tiredness after operation for a long time.

### SUMMARY OF THE INVENTION

An objective of the invention is to provide a mobile communication device and an input module thereof which can be easily operated and avoid the damage caused by an external force.

According to the invention, an input module of a mobile communication device includes an interlinking unit, an input unit, and a pressing unit. The interlinking unit has a protrusion and a first sliding member. The input unit has a second sliding member opposite to the first sliding member. The pressing unit has a groove, a guiding member, and an elastic member. The groove and the interlinking unit move together. One end of the guiding member moves between a first position and a second position in the groove. The elastic member provides a resilience force for the groove. When an external force is applied to the protrusion of the interlinking unit, the interlinking unit drives the groove to move in a first direction to allow the guiding member to relatively move from the first position to the second position or from the second position to the first position.

According to the invention, a mobile communication device includes a housing and an input module. At least one portion of the input module is disposed in the housing. The input module includes an interlinking unit, an input unit, and a pressing unit. The interlinking unit has a protrusion and a first sliding member. The input unit has a second sliding member opposite to the first sliding member. The pressing unit has a groove, a guiding member, and an elastic member. The groove and the interlinking unit move together. One end of the guiding member moves between a first position and a second position in the groove. The elastic member provides a resilience force for the groove. When an external force is applied to the protrusion of the interlinking unit, the interlinking unit drives the groove to move in a first direction to allow the guiding member to relatively move from the first position to the second position or from the second position to the first position.

As described above, when the mobile communication device and the input module thereof according to the invention are to be used, the pressing unit moves and drives the interlinking unit to move by applying an external force to the protrusion of the interlinking unit, and the input unit is thus lifted to be higher than the housing surface of the mobile communication device. When the input module is not to be used, the pressing unit moves and drives the interlinking unit to move also by applying an external force to the protrusion of the interlinking unit, and the input unit is thus lowered, thereby allowing the input member to retract to the housing surface of the mobile communication device.

According to the invention, it facilitates operation for the mobile communication device and the input module thereof by lifting the input unit, thereby releasing users from tiredness after operation for a long time. When they are not to be used, it can prevent the input unit from being damaged because of impact caused by an external force by lowering the input unit.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing an input module of a conventional mobile communication device;

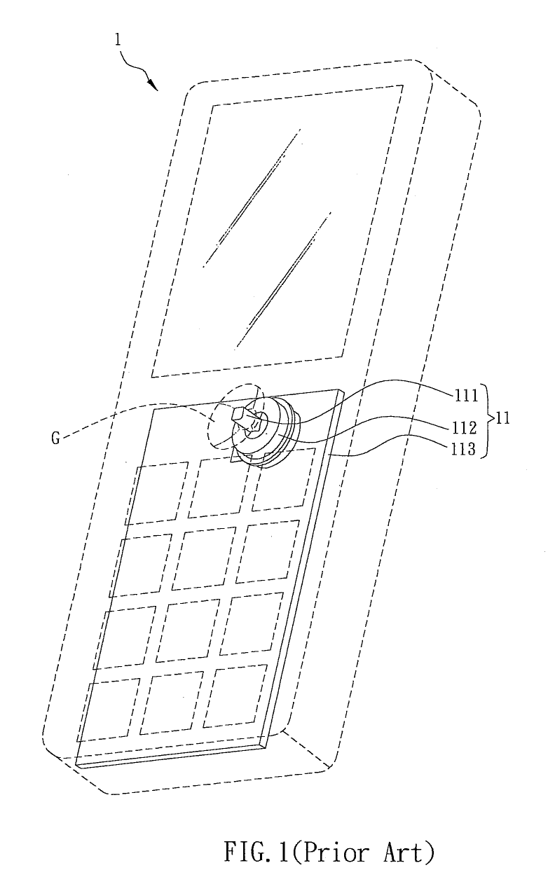

FIG. 2 is a schematic diagram showing a mobile communication device according to a preferred embodiment of the invention;

FIG. 3 is a schematic diagram showing an input module of a mobile communication device according to a preferred embodiment of the invention;

FIG. 4A is a top view showing a guiding member of an input module in a first position according to the invention, and FIG. 4B is a sectional view showing a guiding member of an input module in a first position along the line A-A′ in FIG. 2 according to the invention;

FIG. 5A is a top view showing a guiding member of an input module in a right track, and FIG. 5B is a sectional view showing a guiding member of an input module in a right track along the line A-A′ in FIG. 2 according to the invention;

FIG. 6A is a top view showing a guiding member of an input module in a second position according to the invention, and FIG. 6B is a sectional view showing a guiding member of an input module in a second position along the line A-A′ in FIG. 2 according to the invention; and

FIG. 7A is a top view showing a guiding member of an input module in a left track, and FIG. 7B is a sectional view showing a guiding member of an input module in a left track along the line A-A′ in FIG. 2 according to the invention.

### DETAILED DESCRIPTION OF THE INVENTION

A mobile communication device and an input module according to the invention are described referring to the related drawings hereinbelow.

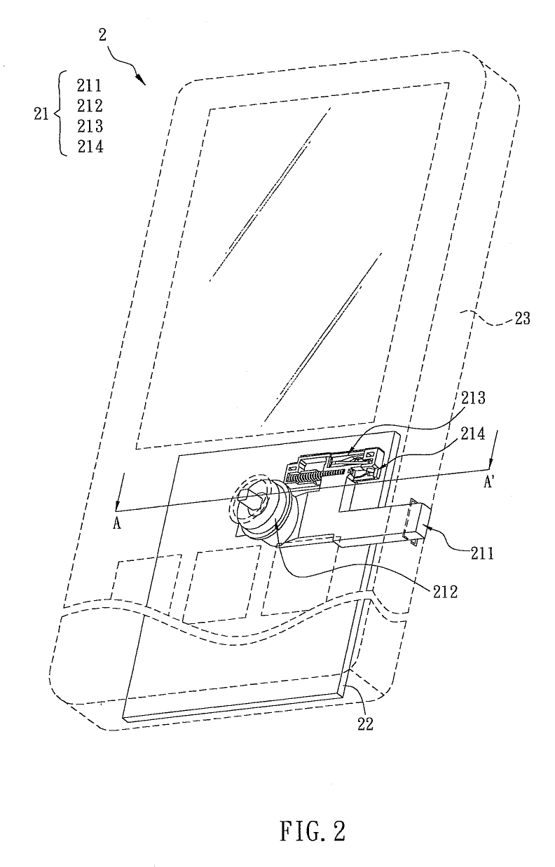

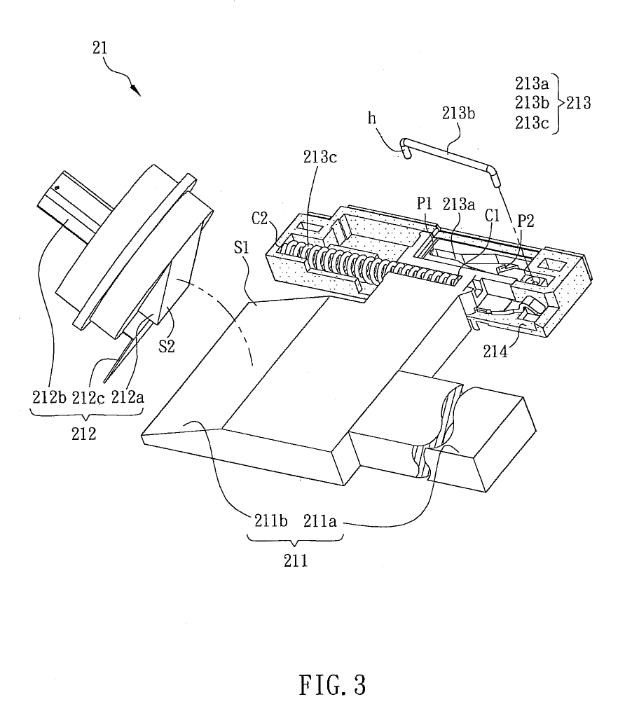

Please refer to FIG. 2 and FIG. 3 together. An input module 21 of a mobile communication device 2 according to the invention includes an interlinking unit 211, an input unit 212, and a pressing unit 213.

The interlinking unit 211 has a protrusion 211 a and a first sliding member 211 b which are integrally formed, and the first sliding member 211 b has an inclined surface S1.

The input unit 212 has a second sliding member 212a which has an inclined surface S2. The first sliding member 211b of the interlinking unit 211 is provided at the bottom of the input unit 212. The inclined surface S1 of the first sliding member 211b is opposite to the inclined surface S2 of the second sliding member 212a. The input unit 212 further includes an input member 212b and a flexible circuit board 212c. The input member 212b may be a joystick body electrically connected to the flexible circuit board 212c using, for example, the surface mount technology. The flexible circuit board 212c is electrically connected to a circuit substrate 22 of the mobile communication device 2 in a mode of, for example, soldering.

The pressing unit 213 has a groove 213a, a guiding member 213b, and an elastic member 213c. The groove 213a is, for example, heart-shaped, and the bottom surface of the groove 213a has a plurality of level differences. The groove 213a and the interlinking unit 211 move together. One end of the guiding member 213b has a hook portion h which moves between a first position P1 and a second position P2 in the groove 213a. The level difference of the bottom surface of the groove 213a in the first position P1 is less than that in the second position P2. Further, the elastic member 213c may be a torque spring for providing a resilience force for the groove 213a.

In this embodiment, the input module 21 further includes a base 214. The pressing unit 213 is provided on the base 214, and the other end of the guiding member 213b is fixed to the base 214. The base 214 does not move with the groove 213a, and therefore the other end of the guiding member 213b does not move with the groove 213a, either. Further, one end C1 of the elastic member 213c is fixed to the interlinking unit 211 and moves with the interlinking unit 211 together; the other end C2 of the elastic member 213c is fixed to the base 214 and does not move with the interlinking unit 211 together.

Next, as shown in FIG. 2 and FIG. 4A to FIG. 7B, the motion of the input module 21 is described.

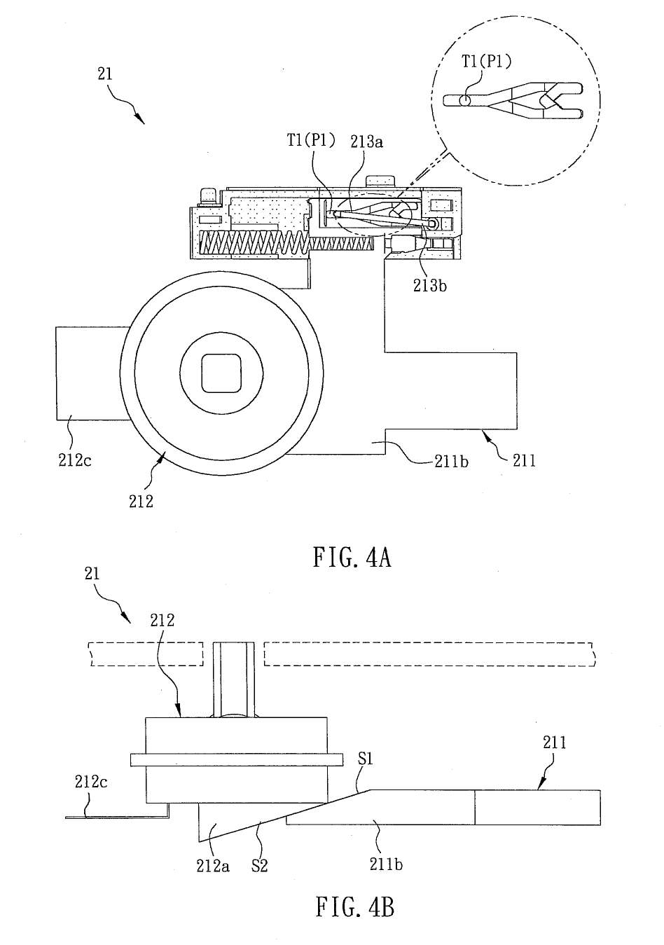

Please refer to FIG. 2, FIG. 4A, and FIG. 4B together. FIG. 4A is a top view showing the input module 21, and FIG. 4B is a sectional view showing the input module 21 along the line A-A′ in FIG. 2. When the input unit 212 is not lifted at first, the guiding member 213b of the pressing unit 213 is in the first position P1 which is on the top T1 of the groove 213a. At this moment, the contacting surface between the inclined surface S1 of the first sliding member 211b of the interlinking unit 211 and the inclined surface S2 of the second sliding member 212a of the input unit 212 is small or does not exist.

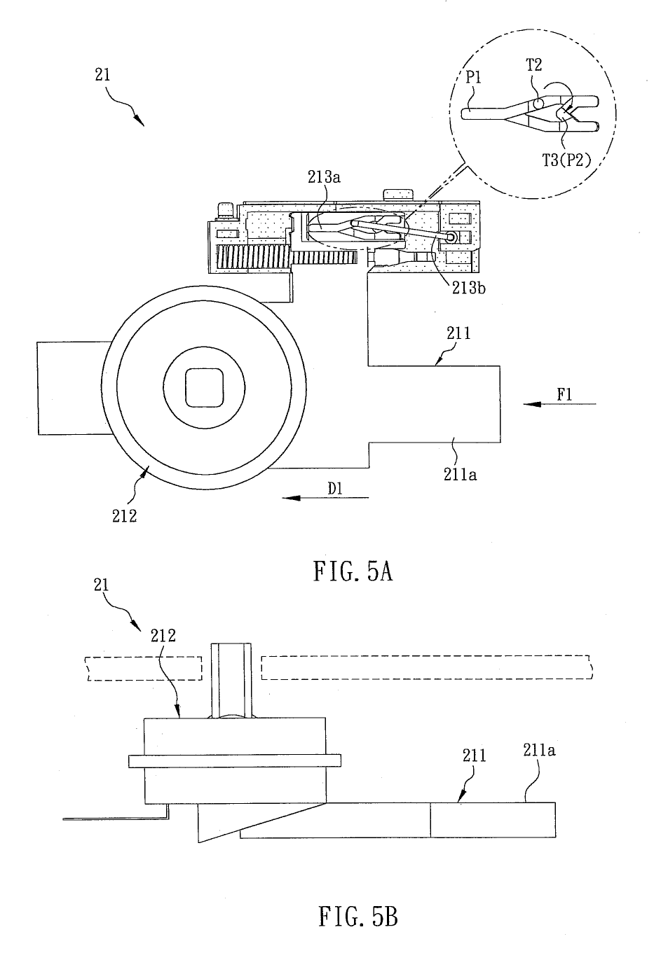

Please refer to FIG. 2, FIG. 5A, and FIG. 5B together. FIG. 5A is a top view showing the input module 21, and FIG. 5B is a sectional view showing the input module 21 along the line A-A′ in FIG. 2. When an external force F1 is applied to the protrusion 211 a of the interlinking unit 211, the interlinking unit 211 drives the groove 213a to move in a first direction D1. Since the level difference of the bottom surface of the groove in the first position P1 is less than that in the second position P2, the hook portion h of the guiding member 213b gradually relatively moves from the first position P1 to the second position P2 which is on the bottom T3 of the groove 213a by a right track T2 of the groove 213a. At the same time, the contacting surface between the inclined surface S1 of the first sliding member 211b and the inclined surface S2 of the second sliding member 212a gradually increases, thereby allowing the input unit 212 to be lifted accordingly.

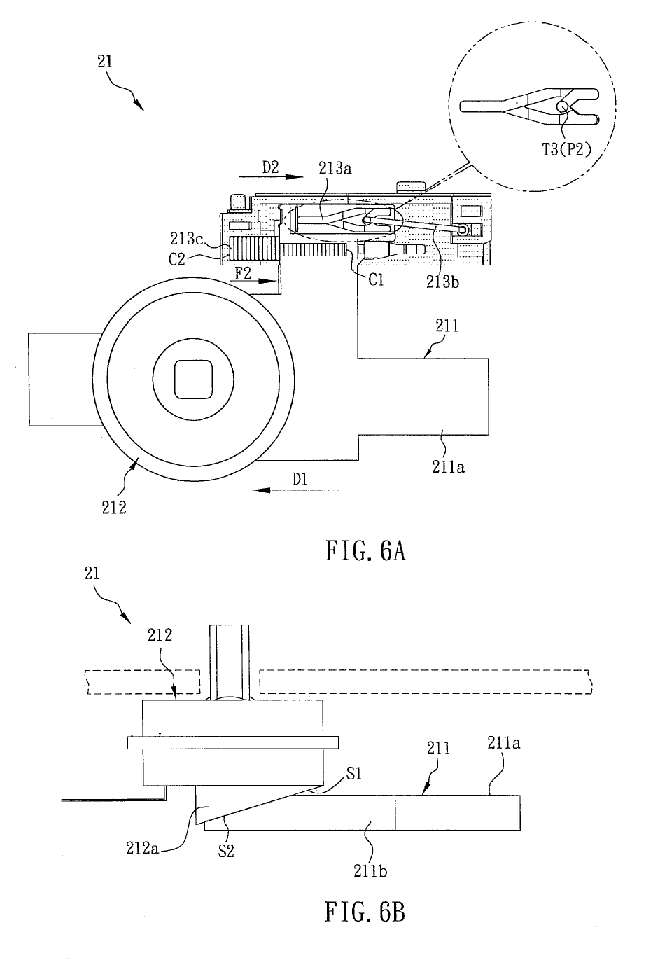

Please refer to FIG. 2, FIG. 6A, and FIG. 6B together. FIG. 6B is a sectional view showing the input module 21 along the line A-A′ in FIG. 2, and FIG. 6A is a top view showing the input module 21. When the guiding member 213b moves to the second position P2, the contacting surface between the inclined surface S1 of the first sliding member 211b and the inclined surface S2 of the second sliding member 212a is the largest to allow the input unit 212 to be lifted to a predetermined height. After being pressed, the elastic member 213c has a resilience force F2 the direction of which is opposite to the first direction D1. Therefore the resilience force F2 of the elastic member 213c makes the interlinking unit 211 and the base 214 relatively far away from each other. That is, when the base 214 is fixed, the resilience force F2 drives the groove 213a to move in the second direction D2. However, the hook portion (not shown) of the guiding member 213b pushes against the second position P2 which is on the bottom T3 of the groove 213a, and the height of the second position P2 is lower than that of any position in the right track T2. Therefore the hook portion (not shown) of the guiding member 213b temporarily stays in the second position P2, thereby allowing the input unit 212 to be lifted to a position of a predetermined height thus to facilitate the input of instructions.

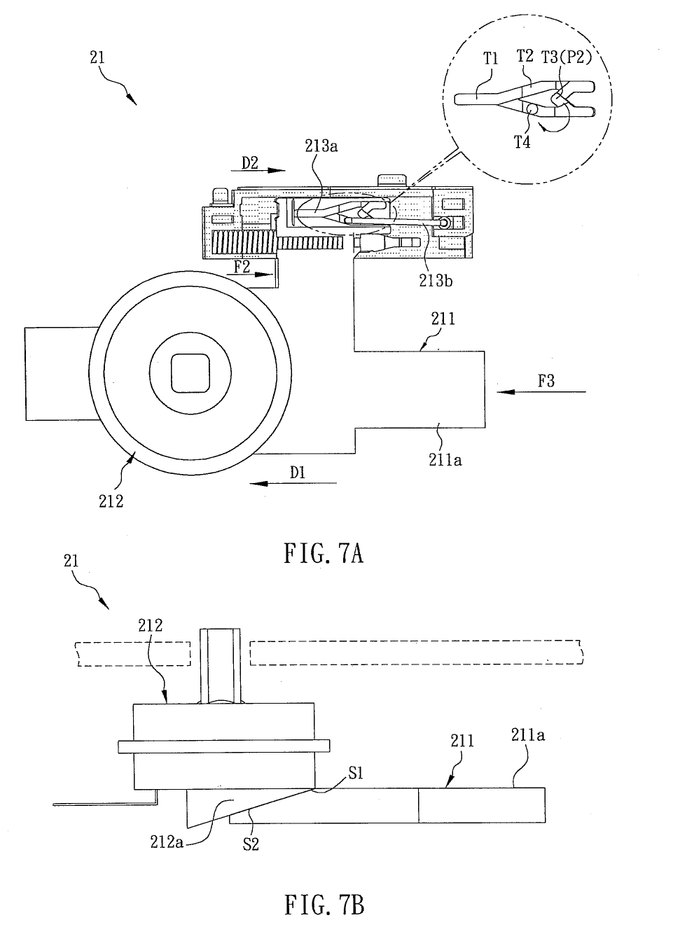

Finally, please refer to FIG. 2, FIG. 7A, and FIG. 7B together. FIG. 7A is a top view showing the input module 21, and FIG. 7B is a sectional view showing the input module 21 along the line A-A′ in FIG. 2. When the input unit 212 is not to be used, an external force F3 is applied to the protrusion 211 a of the interlinking unit 211 to allow the input unit 212 to be lowered. Similarly, the interlinking unit 211 may drive the groove 213a to move in the first direction D1, thereby allowing the guiding member 213b to be away from the second position P2 which is on the bottom T3 of the groove 213a. The level differences of the bottom surfaces of the right track T2, the bottom T3, and a left track T4 reduce in order (that is, in the bottom surfaces of the groove 213a, the right track T2 is the highest; the bottom T3 is the next; the left track T4 is the lowest). Therefore, when the guiding member 213b leaves from the bottom T3 of the groove 213a, it slides to the left track T4. At the same time, the resilience force F2 of the elastic member 213c drives the groove 213a in the second direction D2, and the guiding member 213b moves to the first position P1 which is on the top T1 of the groove 213a along the left track T4. The contacting surface between the inclined surface S1 of the first sliding member 211b of the interlinking unit 211 and the inclined surface S2 of the second sliding member 212a of the input unit 212 is small again or even does not exist, and the input unit 212 is lowered to the original position.

The aforementioned motion makes a cycle. As long as an external force is repeatedly applied to the protrusion 211a, the input unit 212 can be repeatedly lifted or lowered accordingly. Further, the level differences of the bottom surfaces of the right track T2, the bottom T3, and the left track T4 of the groove 213 a reduce in order. Therefore, if the moving direction of the guiding member 213b is reversed, the guiding member 213b fails to be fastened by overstriding the level differences to reach the second position P2. Therefore the order of the moving direction of the guiding member 213b is fixed. Since the groove 213a can have the different structure and shape, the invention is not limited thereto. As long as level differences exist in the groove 213a thus to form a circular travel, they are all embodied in the embodiment.

Please refer to FIG. 2 and FIG. 3. The mobile communication device 2 includes the input module 21 and a housing 23. At least one portion of the input module 21 is disposed in the housing 23. The input module 21 includes the interlinking unit 211, the input unit 212, and the pressing unit 213. The interlinking unit 211 has the protrusion 211a and the first sliding member 211b. The input unit 212 has the second sliding member 212a opposite to the first sliding member 211b. The pressing unit 213 has the groove 213a, the guiding member 213b, and the elastic member 213c. The groove 213a and the interlinking unit 211 move together. One end of the guiding member 213b moves between the first position P1 and the second position P2 in the groove 213a. The elastic member 213c provides the resilience force F2 for the groove.

The housing 23 may be made of plastics, metal, or alloy. The structure and motion of the input module 21 have been described in detail in the aforementioned embodiments, and therefore it is not repeated for concise purpose. In this embodiment, the mobile communication device 2 can further include the circuit substrate 22 electrically connected to the flexible circuit board 212c of the input unit 212. Therefore instructions inputted by the input unit 212 can be transmitted to the circuit substrate 22 through the flexible circuit board 212c.

Please refer to FIG. 5A to FIG. 7B. When the external forces F1, F3 are applied to the protrusion 211 a of the interlinking unit 211, the interlinking unit 211 drives the groove 213a in the first direction D1, thereby relatively moving the guiding member 213b from the first position P1 to the second position P2. The pressing unit 213 moves and drives the interlinking unit 211 to move together. Therefore the input unit 212 is lifted to allow the input member 212b to be higher than the surface of the housing 23 of the mobile communication device 2, or when the interlinking unit 211 drives the groove 213a to move in the first direction D1, the guiding member 213b can relatively move from the second position P2 to the first position P1. The pressing unit 213 moves and drives the interlinking unit 211 to move together. Therefore the input unit 212 is lowered to allow the input member 212b to retract to the surface of the housing 23 of the mobile communication device 2.

As described above, when the mobile communication device and the input module thereof according to the invention are to be used, the pressing unit moves and drives the interlinking unit to move by applying an external force to the protrusion of the interlinking unit, and the input unit is thus lifted to be higher than the surface of the housing of the mobile communication device. When the input module is not to be used, the pressing unit moves and drives the interlinking unit to move also by applying an external force to the protrusion of the interlinking unit, and the input unit is thus lowered, thereby allowing the input member to retract to the surface of the housing of the mobile communication device. Compared with the prior art, it facilitates using the mobile communication device and the input module thereof by lifting the input unit, thereby releasing user from tiredness after operation for a long time. When they are not to be used, it can prevent the input unit from being damaged because of impact caused by an external force by lowering the input unit.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An input module of a mobile communication device, comprising:
an interlinking unit having a protrusion and a first sliding member;
an input unit having a second sliding member opposite to the first sliding member; and
a pressing unit having a groove, a guiding member, and an elastic member, wherein the groove and the interlinking unit move together, one end of the guiding member moves between a first position and a second position in the groove, and the elastic member provides a resilience force for the groove;
when an external force is applied to the protrusion of the interlinking unit, the interlinking unit drives the groove to move in a first direction to allow the guiding member to relatively move from the first position to the second position or from the second position to the first position.

2. The input module according to claim 1, wherein the interlinking unit is integrally formed.

3. The input module according to claim 1, wherein each of the first sliding member and the second sliding member has an inclined surface, respectively.

4. The input module according to claim 1, wherein the input unit has an input member and a flexible circuit board electrically connected with each other.

5. The input module according to claim 4, wherein the flexible circuit board is electrically connected to a circuit substrate.

6. The input module according to claim 1, wherein the first sliding member is provided at the bottom of the input unit.

7. The input module according to claim 1, wherein the input module further comprises:
a base, wherein the pressing unit is provided on the base, and the other end of the guiding member is fixed to the base.

8. The input module according to claim 1, wherein the end of the guiding member has a hook portion.

9. The input module according to claim 1, wherein the bottom of the groove has a plurality of level differences, and the level difference of the first position is less than that of the second position.

10. The input module according to claim 7, wherein one end of the elastic member is fixed to the interlinking unit, and the other end of the elastic member is fixed to the base.

11. A mobile communication device, comprising:
a housing; and
an input module at least one portion of which is disposed in the housing, the input module comprising:
an interlinking unit having a protrusion and a first sliding member;
an input unit having a second sliding member opposite to the first sliding member; and
a pressing unit having a groove, a guiding member, and an elastic member, wherein the groove and the interlinking unit move together, one end of the guiding member moves between a first position and a second position in the groove, and the elastic member provides a resilience force for the groove;
wherein when an external force is applied to the protrusion of the interlinking unit, the interlinking unit drives the groove to move in a first direction to allow the guiding member to relatively move from the first position to the second position or from the second position to the first position.

12. The mobile communication device according to claim 11, wherein the interlinking unit is integrally formed.

13. The mobile communication device according to claim 11, wherein each of the first sliding member and the second sliding member has an inclined surface, respectively.

14. The mobile communication device according to claim 11, wherein the input unit has an input member and a flexible circuit board electrically connected with each other.

15. The mobile communication device according to claim 14, wherein the flexible circuit board is electrically connected to a circuit substrate.

16. The mobile communication device according to claim 11, wherein the first sliding member is provided at the bottom of the input unit.

17. The mobile communication device according to claim 11, wherein the input module further comprises:
a base, wherein the pressing unit is provided on the base, and the other end of the guiding member is fixed to the base.

18. The mobile communication device according to claim 11, wherein the end of the guiding member has a hook portion.

19. The mobile communication device according to claim 11, wherein the groove is heart-shaped.

20. The mobile communication device according to claim 11, wherein the bottom of the groove has a plurality of level differences, and the level difference of the first position is less than that of the second position.

21. The mobile communication device according to claim 17, wherein one end of the elastic member is fixed to the interlinking unit, and the other end of the elastic member is fixed to the base.
